(19) United States
(12) Patent Application Publication
(10) Pub. No.: US 2026/0146557 A1
(43) Pub. Date: May 28, 2026

(54) AFTERCOOLER WITH TUBE AND FIN DESIGN

(71) Applicant: Caterpillar Inc., Peoria, IL (US)

(72) Inventors: Dongming Tan, Eastvale, CA (US); Rohit K. Paramatmuni, Peoria, IL (US); Jianping Zheng Li, Peoria, IL (US); Zheng Zhang, Dunlap, IL (US); Albert Y. Lee, Edwards, IL (US); Cheng Tang, Peoria, IL (US); Ming Tian, Dunlap, IL (US)

(73) Assignee: Caterpillar Inc., Peoria, IL (US)

(21) Appl. No.: 18/956,534

(22) Filed: Nov. 22, 2024

(51) Int. Cl. F01P 11/04; F01P 3/18; F28F 1/12; F28F 9/02

(52) U.S. Cl. CPC F01P 11/04; F01P 3/18; F28F 1/12; F28F 9/0246

(57) ABSTRACT

An aftercooler for an internal combustion engine includes a core assembly. The core assembly can have a plurality of tubes coupled to a first header plate and can receive a cooling fluid from a manifold assembly. The core assembly can have a plurality of fins coupled to the plurality of tubes. At least a first tube of the plurality of tubes closest to an initial intake of a charge air and closest to the first side sheet is exposed and free of the plurality of fins for a first distance from the first header plate. At least a majority of the plurality of tubes including up to all but the at least the first tube are exposed and free of the plurality of fins for a second distance from the first header plate. The second distance is less than the first distance.

### TECHNICAL FIELD

The present disclosure relates to aftercoolers for internal combustion engines. More particularly, the present disclosure relates to an aftercooler that includes a modified arrangement of tubes and fin for the aftercooler.

### BACKGROUND

Machinery, for example, military, marine transport, agricultural, industrial, construction or other heavy machinery can be propelled by one or more internal combustion engine(s). Internal combustion engines combust a mixture of air and fuel in cylinders and thereby produce drive torque and power.

A turbocharger can be employed on an internal combustion engine, particularly one operating on diesel fuel, for increasing a pressure of intake air (also called charge or boost air) entering combustion chambers of the engine. An aftercooler, also known as a charge air cooler, is positioned to control the temperature of the intake air after it has traveled through the turbocharger. The primary function of the aftercooler is to lower the temperature of the compressed intake air produced by the turbocharger, thereby increasing the air density, allowing for more efficient combustion within the engine.

Various heat exchangers have been designed that utilize fins to facilitate heat exchange. Examples of such systems include U.S. Patent Application Publication Nos. US2003006677A1, US20170045299A1 and French Application Publication No. FR2538525A1. However, these heat exchangers differ from the present application in various ways. For example, the heat exchangers of the '299A1, '677A1 and '525A1 applications are not used as part of aftercoolers of an internal combustion engine. Additionally, the heat exchangers of the '677A1 and '525A1 applications utilize slotted fins to create additional pathways for heat flow. This slotted fin configuration is not the focus of the present application. The '299A1 application utilizes fins that are separate from flow tubes rather than fins that are coupled with flow channels. Furthermore, the '299A1 application has a different focus than the present application.

### SUMMARY

In an example according to this disclosure, aftercooler for an internal combustion engine is disclosed. The aftercooler can optionally include: a first side sheet; a first header plate coupled with the first side sheet; a manifold assembly coupled to a first side of the first header plate and positioned adjacent the first side sheet, and a core assembly. The manifold assembly is configured to receive a cooling fluid. The core assembly is positioned adjacent a second side of the first header plate. The core assembly is configured to receive and cool a charge air for the internal combustion engine. The core assembly can optionally include: a plurality of tubes coupled to the first header plate and receiving the cooling fluid from the manifold assembly and a plurality of fins coupled to the plurality of tubes. At least a first tube of the plurality of tubes closest to an initial intake of the charge air and closest to the first side sheet is exposed and free of the plurality of fins for a first distance from the first header plate. At least a majority of the plurality of tubes including up to all but the at least the first tube are exposed and free of the plurality of fins for a second distance from the first header plate. The second distance is less than the first distance.

In another example according to this disclosure, an aftercooler for cooling a charge air of an internal combustion engine is disclosed. The aftercooler optionally including: a first side sheet; a first header plate; and a core assembly positioned adjacent the first header plate and the first side sheet. The core assembly optionally including: a plurality of tubes coupled to the first header plate and a plurality of rows of fins coupled to the plurality of tubes. A first fin coupled to at least a first tube of the plurality of tubes closest to the first side sheet has a first distance from the first header plate of between 25 mm and 75 mm, inclusive.

In yet another example according to this disclosure, a method of assembling an aftercooler of an internal combustion engine is disclosed. The method optionally including: providing a first header plate and a first side sheet; coupling a plurality of tubes to the first header plate; coupling at least a first tube of the plurality of tubes to a first plurality of fins while leaving the at least the first tube exposed and free of the first plurality of fins for a first distance from the header plate; coupling a second number of the plurality of tubes to a second plurality of fins while leaving the second number of the plurality of tubes exposed and free of the second plurality of fins for a second distance from the header plate, wherein the second distance is less than the first distance; and positioning the at least the first tube of the plurality of tubes to be a most adjacent of the plurality of tubes to the first side sheet.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a portion of an internal combustion engine having an intake air system including an aftercooler, in accordance with an example of this disclosure.

FIG. 2 is a perspective view of an aftercooler with a schematic of various exemplary flow circuits therethrough, in accordance with an example of the present application.

FIG. 3 is a perspective view of the aftercooler with components such as a header plate removed to further illustrate components of a core assembly such as a plurality of tubes and a plurality of fins, in accordance with an example of the present application.

FIG. 4 is a perspective view of a portion of the aftercooler with the plurality of fins removed showing some of the plurality of tubes coupled to a first header plate at a plurality of joints; FIG. 4 additionally indicates with lines and arrows relative different distances an initial fin of the plurality of fins is recessed away from the first header plate for particular of the plurality of tubes, in accordance with an example of the present application.

FIG. 5A is a first plan view of the aftercooler of FIG. 4 showing a portion of the header plate illustrating some of the plurality of tubes and some of the plurality of fins and illustrating relative locations of initial fins, in accordance with an example of the present application.

FIG. 5B is a second plan view of the aftercooler of FIGS. 4 and 5A in a second plane showing a portion of the header plate and a first side sheet, FIG. 5B further illustrates some of the plurality of tubes and the plurality of fins including the relative locations of initial fins, in accordance with an example of the present application.

FIG. 6 is a perspective view of a portion of the aftercooler with the plurality of fins removed showing the plurality of tubes coupled to a header plate at a plurality of joints; FIG. 6 additionally indicates with lines and arrows relative different distances an initial fin of the plurality of fins is recessed away from the header plate for particular of the plurality of tubes, in accordance with an example of the present application.

FIG. 7A is a first plan view of the aftercooler of FIG. 6 showing a portion of the header plate illustrating some of the plurality of tubes and some of the plurality of fins and illustrating relative locations of initial fins, in accordance with an example of the present application.

FIG. 7B is a second plan view of the aftercooler of FIGS. 6 and 7A in a second plane showing a portion of the header plate and a first side sheet, FIG. 5B further illustrates some of the plurality of tubes and the plurality of fins including the relative locations of initial fins of such tubes, in accordance with an example of the present application.

FIG. 8A is a first plan view of another embodiment of the aftercooler in a first plane illustrating some of the plurality of tubes and relative locations of initial fins for a plurality of rows of fins, in accordance with an example of the present application.

FIG. 8B is a second plan view of the aftercooler of FIG. 8A in a second plane of portions of the header plate and a first side sheet illustrating some of the plurality of tubes and relative locations of initial fins for such tubes, in accordance with an example of the present application.

FIG. 9A is a first plan view of another embodiment of the aftercooler in a first plane of a portion of the header plate illustrating some of the plurality of tubes and relative locations of initial fins for a plurality of rows of fins coupled to such tubes, in accordance with an example of the present application.

FIG. 9B is a second plan view of the aftercooler of FIG. 9A in a second plane of portions of the header plate and a first side sheet illustrating some of the plurality of tubes and relative locations of initial fins for a plurality of rows of fins coupled to such tubes, in accordance with an example of the present application.

FIG. 10A is a first plan view of another embodiment of the aftercooler in a first plane of a portion of the header plate illustrating some of the plurality of tubes and relative locations of initial fins for such tubes, in accordance with an example of the present application.

FIG. 10B is a second plan view of the aftercooler of FIG. 10A in a second plane of portions of the header plate and a first side sheet illustrating some of the plurality of tubes and relative locations of initial fins for such tubes, in accordance with an example of the present application.

### DETAILED DESCRIPTION

Examples according to this disclosure are directed to internal combustion engines, air intake systems thereof and components including an aftercooler. Examples of the present disclosure are now described with reference to the accompanying drawings. The following description is merely exemplary in nature and is not intended to limit the present disclosure, application, or use. Examples described set forth specific components, devices, and methods, to provide an understanding of embodiments of the present disclosure. It will be apparent to those skilled in the art that specific details need not be employed and that examples may be embodied in many different forms. Thus, the examples provided should not be construed to limit the scope of the claims.

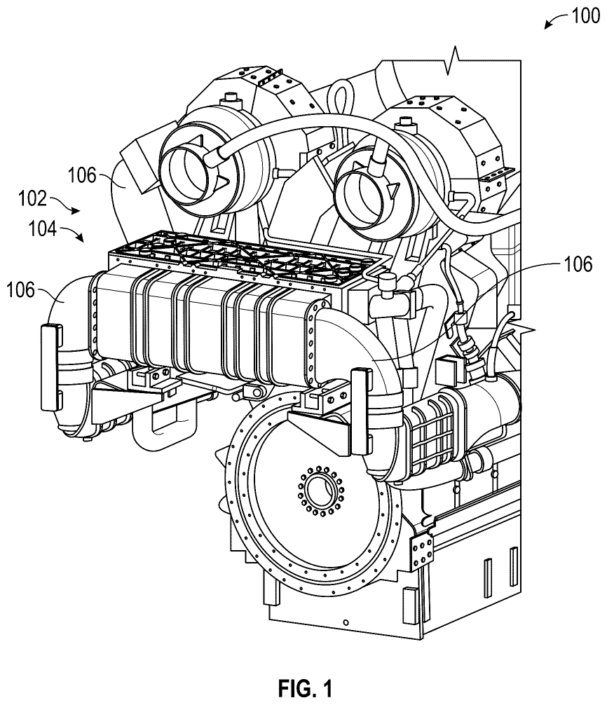

FIG. 1 depicts a portion of an internal combustion engine 100 in accordance with this disclosure. The internal combustion engine 100 can be used for power generation such as for the propulsion of vehicles or other machinery. The internal combustion engine 100 can include various power generation platforms, including, for example, gasoline, natural gas, diesel or any other desired fuel. It is understood that the present disclosure can apply to any number of piston-cylinder arrangements and a variety of internal combustion engine configurations including, but not limited to, V-internal combustion engines, inline internal combustion engines, and horizontally opposed internal combustion engines, as well as overhead cam and cam-in-block configurations.

In some applications, the internal combustion engines such as internal combustion engine 100 can be used in stationary applications such as for power generation. In other applications the internal combustion engines disclosed can be used with vehicles and machinery that include those related to various industries, including, as examples, construction, marine transport, military, agriculture, forestry, other transportation, material handling, waste management, etc. The internal combustion engine 100 is configured to operatively drive a load, for example, an electrical generator or other device. The internal combustion engine 100 is mechanically coupled to the generator or other device by an output shaft (e.g., a crankshaft).

The internal combustion engine 100 can include an intake air system 102 including an aftercooler 104 and ducting 106 and various other components such as a supercharger or turbocharger that are not specifically illustrated in FIG. 1. The intake air system 102 can communicate compressed intake air (boost or charge air) from the supercharger or turbocharger through the aftercooler 104 and on to a plurality of combustion chambers of the internal combustion engine 100 and other components known in the art.

The aftercooler 104 is configured to receive the compressed intake air from the ducting 106, pass the intake air through a heat exchange relationship to cool the intake air and then pass the cooled intake air (referred to elsewhere herein as charge air) via the ducting 106 to the combustion chambers of the internal combustion engine 100. The aftercooler 104 can be configured to use at least a second fluid (e.g., jacket water, other water, oil, coolant, water-glycol, air, mixtures thereof, etc.) as a cooling fluid. In some examples, two or more different cooling fluids or a same fluid but with separate fluid flows at different temperatures can be used as the cooling fluid. The cooling fluid can be in a heat exchange relationship with the charge air within a core assembly (not shown) of the aftercooler 104. The internal combustion engine 100 can be provided with an intake manifold being in fluid communication with each of the plurality of combustion chambers by the ducting 106 or other mechanism.

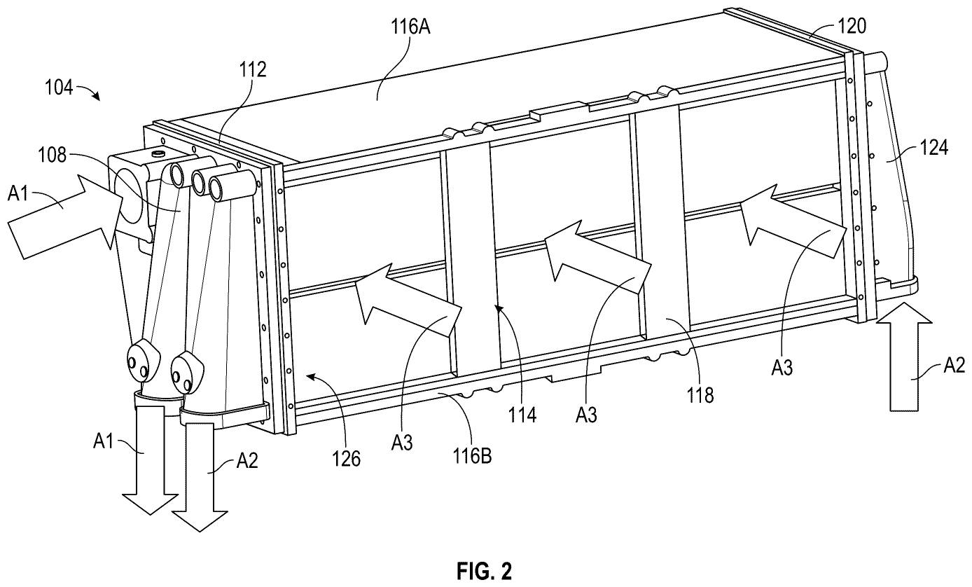

FIG. 2 is a perspective view of the aftercooler 104 with relative fluid flow directions indicated with arrows according to one embodiment. The aftercooler 104 has an open frame construction for communicating with the ducting 106 (not shown but illustrated in FIG. 1) and can include a first manifold assembly 108, a first header plate 112, a core assembly 114, a first side sheet 116A, a second side sheet 116B, one or more tie bars 118, a second header plate 120 and a second manifold assembly 124.

The first manifold assembly 108 can be coupled to ducting, piping, lines, etc. (not shown but piping examples illustrated but not labeled in FIG. 1) for introduction or outflow of one or more cooling fluid(s). The first manifold assembly 108 can be coupled to a first side of the first header plate 112.

The core assembly 114 can be positioned adjacent a second side of the first header plate 112. Components of the core assembly 114 such as the plurality of tubes (discussed and shown subsequently) can extend into and can be coupled with the first header plate 112 according to some embodiments. In operation, the core assembly 114 is configured to receive both the cooling fluid(s) from the first manifold assembly 108 and receive the charge air. The core assembly 114 can cool the charge air for the internal combustion engine using the cooling fluid(s). The core assembly 114 can have an elongate extent and can be constructed of suitable material(s) such as heat conductive metal(s) (e.g., copper, nickel, or combinations thereof). The core assembly 114 can include a plurality of flow passages allowing the charge air to pass therebetween in the heat conductive relationship with the cooling fluid. Similarly, the core assembly 114 can have a plurality of flow passages allowing the cooling fluid(s) to pass therethrough.

The first side sheet 116A and the second side sheet 116B can be positioned adjacent opposing sides of the core assembly 114. The first side sheet 116A and the second side sheet 116B can be configured to partially contain the flow of the charge air through the core assembly 114. The one or more tie bars 118 can extend between the first side sheet 116A and the second side sheet 116B and can be coupled thereto. The one or more tie bars 118 can be positioned adjacent and to either side of the core assembly 114.

The second header plate 120 can be positioned adjacent the core assembly 114 on an opposing side thereof from the first header plate 112. Components of the core assembly 114 such as the plurality of tubes (discussed and shown subsequently) can extend into and can be coupled with the second header plate 120 according to some examples. The second manifold assembly 124 can be coupled to the second header plate 120.

The aftercooler 104 can have an open frame design with openings 126 that allow for passage of the charge air to the core assembly 114. Although not shown in FIG. 2, ducting 106 of the intake air system 102 (FIG. 1) can be placed over and coupled to ends of the first side sheet 116A and the second side sheet 116B and/or to other components for conveying the charge air to and from the core assembly 114.

FIG. 2 illustrates example flows of a first cooling fluid (arrows A1), a second cooling fluid (arrows A2) and the charge air (arrows A3) through the aftercooler 104. It should be noted that the flow circuits of FIG. 2 are purely exemplary and the concepts of the present application are applicable to other aftercooler designs including those that only utilize a single cooling fluid or three or more cooling fluids. Furthermore, the cross-flow and/or cooling flow circuit geometries illustrated are purely exemplary and can be modified according to further examples.

In the example of FIG. 2, the aftercooler 104 is configured for two stages of cooling of the charge air including higher temperature cooling and lower temperature cooling. Thus, for example, the first manifold assembly 108 can be configured to receive the first cooling fluid (e.g., lower temperature water, coolant, oil, lower temperature air, etc.) and pass this to a first section of the core assembly 114 and through the core assembly 114 to the second manifold assembly 124. According to the embodiment of FIG. 2, the aftercooler 104 is configured such that the first cooling fluid turns in the second manifold assembly 124 and re-enters the core assembly 114 passing back through a second section of the core assembly 114 to the first manifold assembly 108 and then exits therefrom into ducting (not shown).

The second manifold assembly 124 can additionally be configured to receive the second cooling fluid (e.g., jacket water at higher temperature, other water at higher temperature, higher temperature oil, higher temperature air, etc.) and pass this to another higher temperature section of the core assembly 114 and through the core assembly 114 to the first manifold assembly 108. The second cooling fluid can be discharged from the first manifold assembly 108 as shown in FIG. 2. However, other embodiments for the aftercooler contemplate that the second cooling fluid could be passed back through the core assembly 114 in an opposing direction in the manner of the first cooling fluid.

FIG. 2 shows the charge air flowing into and through the core assembly 114 via one of the openings 126 in a direction generally perpendicular to the flow direction of the first cooling fluid and the second cooling fluid. This cross-flow heat transfer arrangement results in cooling of the charge air for use in the combustion chambers as described previously.

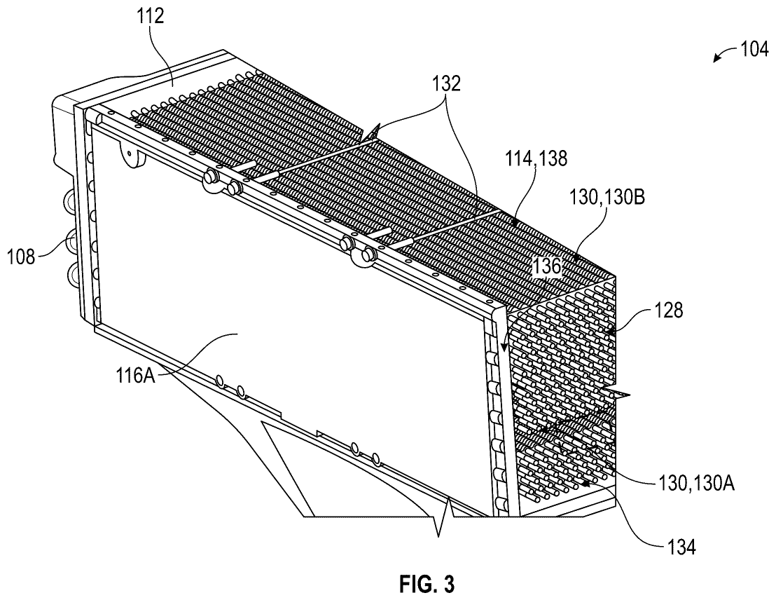

FIG. 3 shows a portion of the aftercooler 104 from a different perspective than FIG. 2 with the first side sheet 116A to the left of the core assembly 114 rather than being above and below as was previously the case. Additionally, the second manifold assembly 124 (FIG. 2) and the one or more tie bars 118 (FIG. 2) are removed in FIG. 3 to show further details of the core assembly 114. FIG. 3 shows the first manifold assembly 108, the first header plate 112, the core assembly 114 and the first side sheet 116A as previously discussed. Additionally, the core assembly 114 as shown in FIG. 3 includes a plurality of tubes 128, a plurality of fins 130 and one or more stiffener plates 132.

FIG. 3 shows the aftercooler 104 having the core assembly 114 separated into a higher temperature stage 134 and a lower temperature stage 136 as previously discussed in FIG. 2. The higher temperature stage 134 can be spaced from the lower temperature stage 136.

As shown in FIG. 3, the plurality of tubes 128 can extend through and can be received by the plurality of fins 130. The plurality of fins 130 can be coupled to the plurality of tubes 128. The plurality of tubes 128 can transport the cooling fluid(s) through the core assembly 114. The plurality of tubes 128 can have a diameter that can vary according to aftercooler application. Only the ends of the plurality of tubes 128, which are typically be coupled to the header plate are shown in FIG. 3 as the remainder of the elongate length thereof is obstructed by the plurality of fins 130.

The plurality of fins 130 can be elongate but relatively thin plate-like structures. The plurality of fins 130 can be arranged in a plurality of rows 138 spaced substantially parallel to one another and to the first header plate 112. The plurality of rows 138 extend between (but are spaced from) the first side sheet 116A and the second side sheet 116B. The orientation of the plurality of fins 130 spaced in the plurality of rows 138 creates passages/gaps for flow of the charge air therebetween as previously discussed. Spacing of the plurality of rows 138 can vary with application and type of the aftercooler. As an example, multiple rows of the plurality of fins 130 can be arranged per centimeter. The plurality of tubes 128 and the plurality of fins 130 can be constructed of suitable material(s) such as heat conductive metal(s) (e.g., copper, nickel, or combinations thereof).

As shown in FIG. 3, the plurality of tubes 128 can be coupled with respectively arranged groups of the plurality of fins 130. The plurality of tubes 128 can support the plurality of fins 130 within the aftercooler 104. The plurality of tubes 128 can be arranged in several groups and in rows, for example. These groups include a plurality of tubes 128 received by a plurality of fins 130A of the higher temperature stage 134, and another plurality of tubes 128 received by a plurality of fins 130B of the lower temperature stage 136, for example. It should be noted that the lower temperature stage 136 can be further broken into third pluralities of the fins and tubes not specifically numbered. This is due to the out-and-back flow of the lower temperature cooling fluid as discussed previously.

The one or more stiffener plates 132 are positioned at intervals along the elongate length of the core assembly 114. The one or more stiffener plates 132 support the plurality of tubes 128. The one or more stiffener plates 132 are coupled to the one or more tie bars (not shown in FIG. 3 but shown previously in FIG. 2) and are positioned between the first header plate 112 and the second header plate (not shown) and the first side sheet 116A and the second side sheet 116B (FIG. 2).

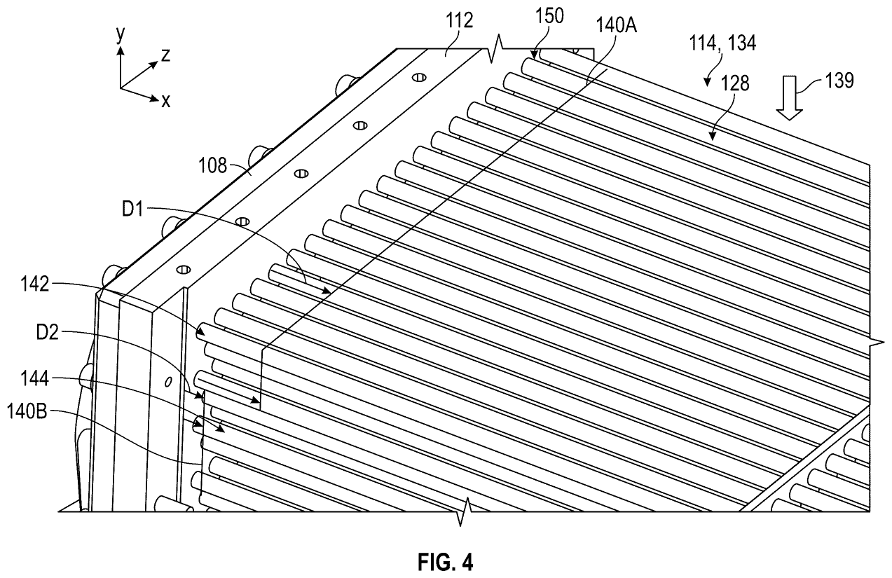

FIG. 4 shows a portion of the core assembly 114 particularly at the higher temperature stage 134 with the plurality of fins and the first side sheet removed. FIG. 4 illustrates portions of the first manifold assembly 108 and the first header plate 112 and the plurality of tubes 128. As the higher temperature stage 134 is illustrated in FIG. 4, FIG. 4 illustrates an area of initial intake 139 of the charge air with the flow direction indicated with an arrow. The plurality of tubes 128 couple with the first header plate 112 at a joint 150 (a tube header joint). The plurality of tubes 128 are in fluid communication with the first manifold assembly 108 and can thereby receive or communicate the cooling fluid(s) from or to the first manifold assembly 108 as previously discussed.

FIG. 4 schematically illustrates with lines the locations of first fins 140A and 140B (also called initial fins herein). The first fins 140A and 140B comprise the fin(s) or row of fins closest adjacent the first header plate 112. As shown in FIG. 4, the first fin 140A has a first distance D1 from the first header plate 112. The first distance D1 can be between 25 mm and 75 mm, inclusive. However, other dimensions for the first distance are contemplated. In contrast, the first fin 140B has a second distance D2 from the first header plate 112. The second distance D2 can be shorter than the first distance D1 and can be between 1.5 mm and 15 mm (e.g., less than 15 mm). Thus, the second distance D2 is less than the first distance D1.

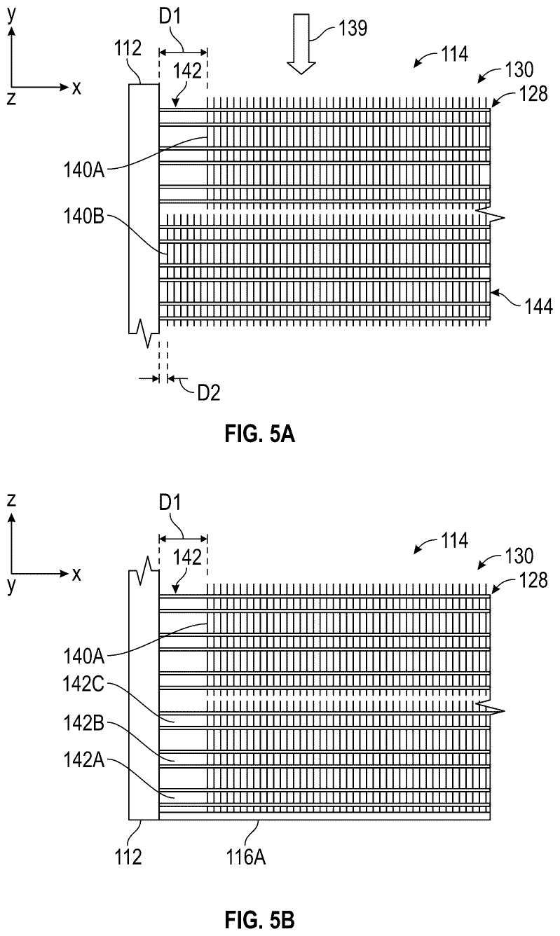

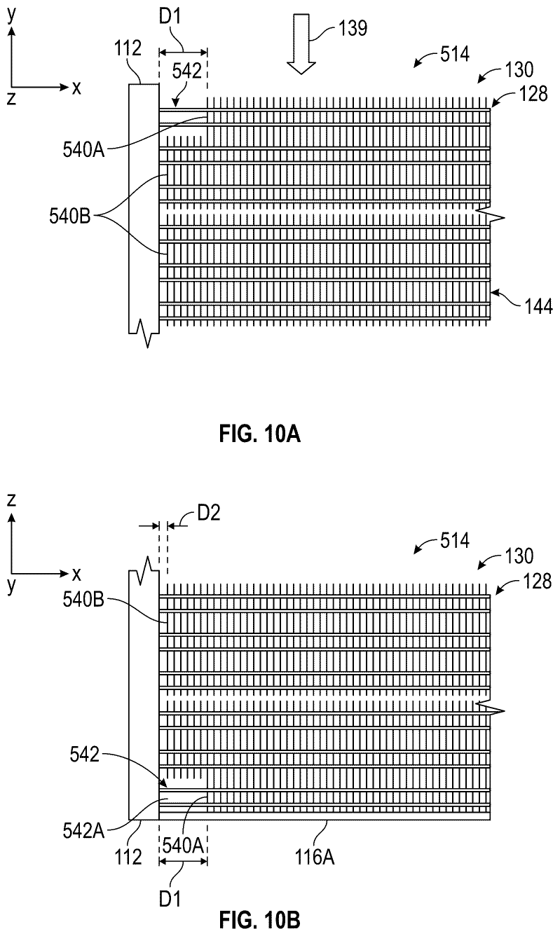

FIG. 4 shows a first tube 142 of the plurality of tubes 128. The first tube 142 can be a single tube (see FIGS. 10A and 10B), can be a plurality of tubes (e.g., between two and fifty tubes, inclusive) or can be between one to five rows of tubes, inclusive (with each row of tubes including between five and fifty tubes). As shown in FIG. 4, the first tube 142 is the tube closest to the initial intake 139 of the charge air and closest to the first side sheet (not shown in FIG. 4 but shown subsequently in FIG. 5B). The first tube 142 is exposed and free of the plurality of fins for the first distance D1 from the first header plate 112 to the line indicated for the first fin 140A. As shown in FIG. 4, at least a majority of the plurality of tubes 128 including up to all but the at least the first tube 142 are exposed and free of the plurality of fins for the second distance D2 from the first header plate 112. However, as noted above, the second distance D2 is less than the first distance D1.

As shown in FIG. 4, the first tube 142 includes the three tubes closest to the first side sheet (not shown in FIG. 4 but shown subsequently in FIG. 5B) and three rows of tubes closest to the initial intake 139 of the charge air. Additionally, the at least a majority of the plurality of tubes 128 (tubes excluding the first tube 142) are positioned at an inner region 144 of the core assembly 114 inward of the at least the first tube 142 relative to at least one of: the initial intake 139 of the charge air and the first side sheet (not shown in FIG. 4). Also, as shown in FIG. 4, at least the first tube 142 of the plurality of tubes closest to the first side sheet 116A has relatively less of the plurality of rows of the plurality of fins 130 coupled thereto compared with others of the plurality of tubes 128 as a result of the at least the first tube 142 being exposed and free of the plurality of rows of the plurality of fins 130 for a first distance from the first header plate 112.

FIG. 4 includes a Cartesian coordinate system and FIGS. 5A and 5B utilize the same Cartesian coordinate system. FIGS. 5A and 5B show portions of the core assembly 114, the first header plate 112, some of the plurality of tubes 128 including the first tube 142, the first distance D1, the second distance D2 (FIG. 5A only) and some of the plurality of fins 130 including the first fins 140A and 140B of FIG. 4. FIG. 5B additionally illustrates a portion of the first side sheet 116A. FIG. 5A shows the initial intake 139 of the charge air with arrow indicating the flow direction and the inner region 144 below an outer region positioned adjacent the initial intake 139.

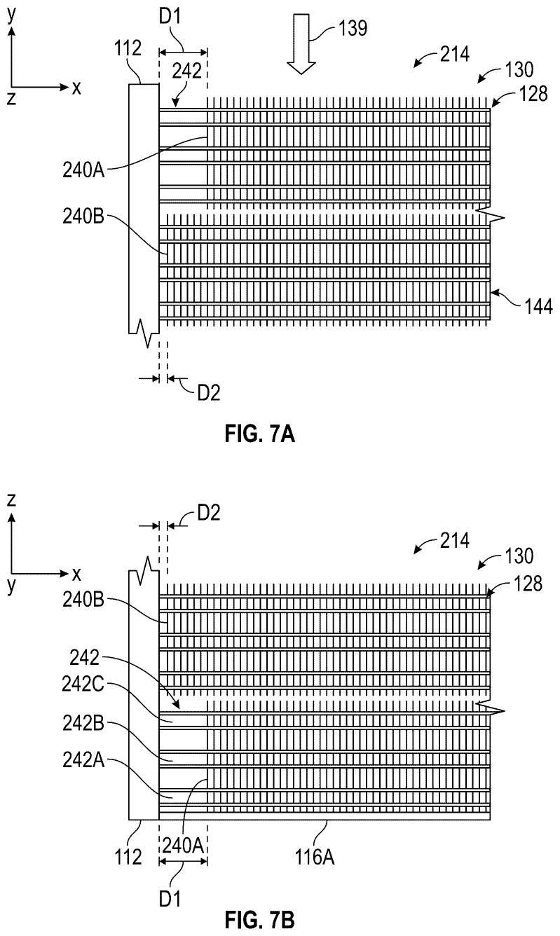

FIGS. 5A and 5B are two dimensional depictions of portions of the core assembly 114 and the first header plate 112. As such, it is understood that further fins and tubes generally aligned in rows with the plurality of fins 130 and the plurality of tubes 128 are obstructed in FIGS. 5A and 5B. Similar obstruction of rows of fins and tubes occurs in FIGS. 7A, 7B, 8A, 8B, 9A, 9B, 10A and 10B. FIG. 5A shows arrangements of the plurality of tubes 128 attached to the first header plate 112 and the plurality of fins 130 attached to the plurality of tubes 128 in a flow depth dimension along a direction of the airflow through the core assembly 114 including at the area adjacent the initial intake 139. As discussed previously in regard to FIG. 4 and now illustrated in FIG. 5A, the first tube 142 can include three rows of tubes closest to the initial intake 139 of the charge air. The first fin 140A is coupled to the first tube 142 and is the fin closest adjacent the first header plate 112 (spaced therefrom the first distance D1). As a consequence of this arrangement, the first tube 142 is exposed and free of the plurality of fins 130 for the first distance D1 from the first header plate 112. FIG. 5A illustrates that in the inner region 144, the first fin 140B is positioned relatively closer to the first header plate 112 (spaced the second distance D2) as compared with the first fin 140A. As a consequence of this arrangement, the plurality of tubes 128 in the inner region 144 are exposed and free of the plurality of fins 130 for the second distance D2 from the first header plate 112.

FIG. 5B shows the arrangements of the plurality of tubes 128 attached to the first header plate 112 and the plurality of fins 130 attached to the plurality of tubes 128 in a dimension perpendicular to the direction of airflow through the core assembly 114. FIG. 5B shows the arrangement of the plurality of tubes 128 and the plurality of fins 130 relative to the first header plate 112 and the first side sheet 116A. FIG. 5B shows the first fin 140A and the first tube 142. As shown in FIG. 5B, the first tube 142 includes the three tubes 142A, 142B and 142C closest to the first side sheet 116A and additional tubes not specifically numbered. However, the first tube 142 can include any number of the plurality of tubes 128 (from one single tube including up to all the tubes in one or more rows arranged between the first side sheet 116A and the second side sheet (not shown)).

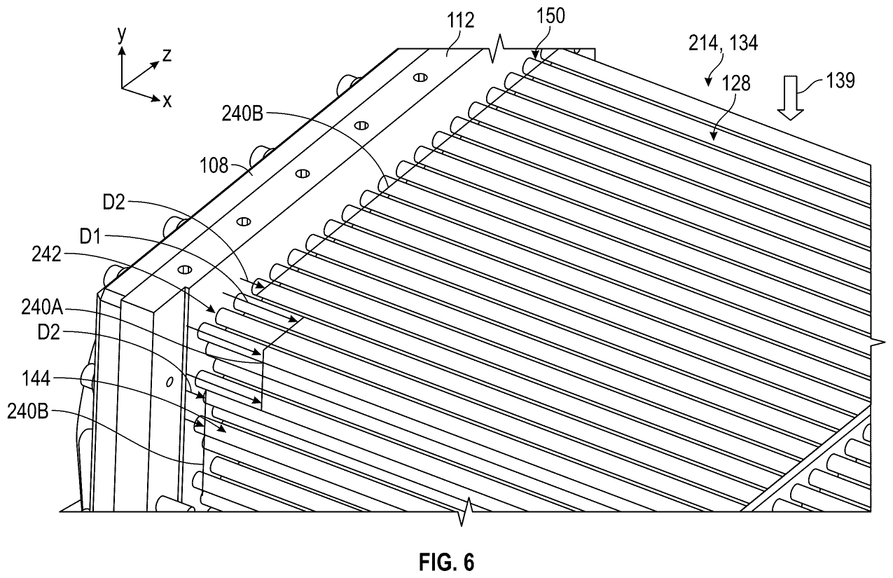

FIG. 6 shows another example of a core assembly 214 according to another embodiment of the present application. FIG. 6 shows a portion of the core assembly 214 particularly at the higher temperature stage 134 with the plurality of fins and the first side sheet removed. FIG. 6 illustrates portions of the first manifold assembly 108 and the first header plate 112 with the joint 150 and the plurality of tubes 128. FIG. 6 schematically illustrates with lines the locations of first fins 240A and 240B. The embodiment of FIG. 6 is similar to the embodiment of FIGS. 4-5B described previously but differs in that the number of first tubes 242 spaced at the first distance D1 from the first header plate 112 is reduced to the three tubes closest to the first side sheet (not shown in FIG. 6 but shown subsequently in FIG. 7B) and portions of three rows of tubes closest to the initial intake 139 of the charge air. Thus, in the example of FIG. 6, nine tubes have the first distance D1.

FIGS. 7A and 7B show portions of the core assembly 214, the first header plate 112, some of the plurality of tubes 128 including the first tube 242, the first distance D1, the second distance D2 and some of the plurality of fins 130 including the first fins 240A and 240B of FIG. 6. FIG. 7B additionally illustrates a portion of the first side sheet 116A. FIG. 7A shows the initial intake 139 of the charge air with arrow indicating the flow direction and the inner region 144 below an outer region positioned adjacent the initial intake 139.

FIG. 7A shows arrangements of the plurality of tubes 128 attached to the first header plate 112 and the plurality of fins 130 attached to the plurality of tubes 128 in a flow depth dimension along a direction of the airflow through the core assembly 214 including at the area adjacent the initial intake 139. The first tube 242 can include only portions (e.g., three tubes each) of three rows of tubes closest to the initial intake 139 of the charge air. The first fin 240A is coupled to the first tube 242 and is the fin closest adjacent the first header plate 112 (spaced therefrom the first distance D1). As a consequence of this arrangement, the first tube 242 is exposed and free of the plurality of fins 130 for the first distance D1 from the first header plate 112. FIG. 7A illustrates that in the inner region 144 (and indeed in other regions as previously shown in FIG. 6), the first fin 240B is positioned relatively closer to the first header plate 112 (the second distance D2) as compared with the first fin 240A. As a consequence of this arrangement, the plurality of tubes 128 in the inner region 144 are exposed and free of the plurality of fins 130 for the second distance D2 from the first header plate 112.

FIG. 7B shows the arrangements of the plurality of tubes 128 attached to the first header plate 112 and the plurality of fins 130 attached to the plurality of tubes 128 in a dimension perpendicular to the direction of airflow through the core assembly 214. FIG. 7B shows the arrangement of the plurality of tubes 128 and the plurality of fins 130 relative to the first header plate 112 and the first side sheet 116A. FIG. 7B shows the first fin 240A, the first fin 240B and the first tube 242. As shown in FIG. 7B, the first tube 142 includes only the three tubes 242A, 242B and 242C closest to the first side sheet 116A. FIG. 7B additionally shows the difference between the spacing of the first fin 240B (spaced the second distance D2) and the first fin 240A (spaced the first distance D1) relative to the first header plate 112.

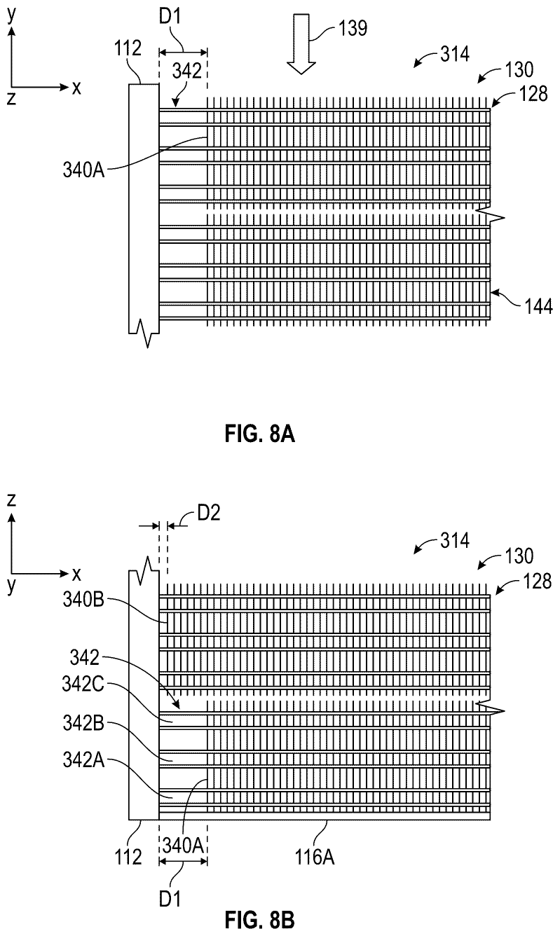

FIGS. 8A and 8B illustrate another example of portions of a core assembly 314 according to another embodiment of the present application. The example of FIGS. 8A and 8B is similar to the core assembly 214 of FIGS. 6-7B but differs in that the number of first tubes 342 with the first fin 340A spaced at the greater first distance D1 from the first header plate 112 is increased from three rows of tubes closest to the initial intake 139 of the charge air to at least portions of six rows of tubes. FIGS. 8A and 8B also illustrate portions of the first header plate 112, some of the plurality of tubes 128 including the first tube 342, the first distance D1, the second distance D2 (shown in FIG. 8B only) and some of the plurality of fins 130 including first fins 340A and 340B (shown in FIG. 8B only). FIG. 8B additionally illustrates a portion of the first side sheet 116A with three tubes 342A, 342B and 342C most adjacent to the first side sheet 116A having the first fin 340A at the first distance D1. FIG. 8A shows the initial intake 139 of the charge air with arrow indicating the flow direction and the inner region 144 below an outer region positioned adjacent the initial intake 139.

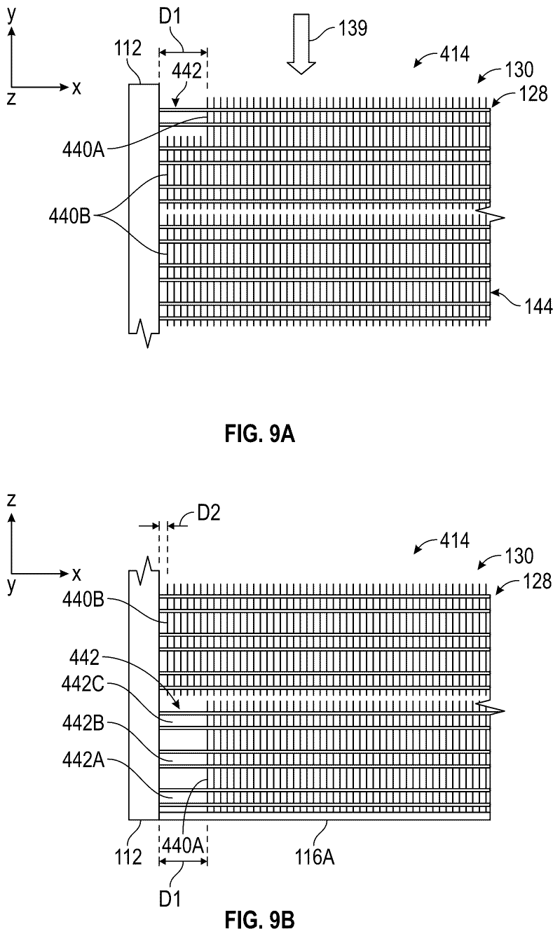

FIGS. 9A and 9B illustrate another example of portions of a core assembly 414 according to another embodiment of the present application. The example of FIGS. 9A and 9B is similar to the core assembly 214 of FIGS. 6-7B but differs in that the number of the first tubes 442 with the first fin 440A spaced at the greater first distance D1 from the first header plate 112 is reduced from three rows of tubes closest to the initial intake 139 of the charge air to only a single portion of a row of tubes. FIGS. 9A and 9B also illustrate portions of the first header plate 112, some of the plurality of tubes 128 including the first tube 442, the first distance D1, the second distance D2 (shown in FIG. 9B only) and some of the plurality of fins 130 including first fins 440A and 440B (shown in FIG. 9B only). FIG. 9B additionally illustrates a portion of the first side sheet 116A with three tubes 442A, 442B and 442C most adjacent to the first side sheet 116A having the first fin 440A at the first distance D1. FIG. 9A shows the initial intake 139 of the charge air with arrow indicating the flow direction and the inner region 144 below an outer region positioned adjacent the initial intake 139.

FIGS. 10A and 10B illustrate another example of portions of a core assembly 514 according to another embodiment of the present application. The example of FIGS. 10A and 10B is similar to the core assembly 214 of FIGS. 6-7B but differs in that the number of first tubes 542 with the first fin 540A spaced at the greater first distance D1 from the first header plate 112 is reduced from three rows of tubes closest to the initial intake 139 of the charge air to only a single tube located most adjacent to the first side sheet 116A as shown in FIG. 10B. FIGS. 10A and 10B also illustrate portions of the first header plate 112, some of the plurality of tubes 128 including the first tube 542, the first distance D1, the second distance D2 (shown in FIG. 10B only) and some of the plurality of fins 130 including first fins 540A and 540B (shown in FIG. 10B only). FIG. 10B additionally illustrates a portion of the first side sheet 116A with single tube 442A most adjacent to the first side sheet 116A having the first fin 440A at the first distance D1. FIG. 10A shows the initial intake 139 of the charge air with arrow indicating the flow direction and the inner region 144 below an outer region positioned adjacent the initial intake 139.

### INDUSTRIAL APPLICABILITY

In operation, the internal combustion engine 100 can be configured to combust fuel to generate power. During operation, the internal combustion engine 100 can utilize charge air for combustion to improve efficiency. The present application contemplates use of the aftercooler 104 for cooling the charge air by heat exchange within the core assembly 114. Heat exchange with the charge air is accomplished by passing the charge air over the plurality of fins 130 arranged in a plurality of rows. FIGS. 4-10B show embodiments where the first fin 140A, 240A, 340A, 440A and 540A of the plurality of fins 130 are spaced the greater first distance D1 from the first header plate 112 than others of the plurality of fins 130, which are spaced the second distance D2 from the first header plate 112.

FIGS. 4-10B show portions of the core assembly 114, 214, 314, 414, and 515 with the plurality of fins 130 coupled to the plurality of tubes 128. The plurality of tubes 128 couple with the first header plate 112 at the joint 150 (a tube header joint numbered specifically in FIGS. 4 and 6). The plurality of tubes 128 are in fluid communication with the first manifold assembly 108 (FIGS. 4 and 6) and can thereby receive or communicate the cooling fluid(s) from or to the first manifold assembly 108. The present application has determined that use of the first distance D1 for the first fin 140A, 240A, 340A, 440A and 540A can reduce the thermal stress on the tube header joints (the joint 150 of FIGS. 4 and 6). This is due to the relatively smaller bending force applied to the joint 150 of FIGS. 4 and 6 if the first fin 140A, 240A, 340A, 440A and 540A is positioned the greater distance (the first distance D1) away from the first header plate 112 as compared with the second distance D2. As a consequence of this arrangement, thermal stress on the joint 150 is reduced and a thermal cycle life of the joint 150 (and hence the plurality of tubes 128) is improved.

The above detailed description is intended to be illustrative, and not restrictive. The scope of the disclosure should, therefore, be determined with references to the appended claims, along with the full scope of equivalents to which such claims are entitled.

What is claimed is:

1. An aftercooler for an internal combustion engine comprising:
a first side sheet;
a first header plate coupled with the first side sheet;
a manifold assembly coupled to a first side of the first header plate and positioned adjacent the first side sheet, wherein the manifold assembly is configured to receive a cooling fluid; and
a core assembly positioned adjacent a second side of the first header plate, the core assembly is configured to receive and cool a charge air for the internal combustion engine, the core assembly comprising:
a plurality of tubes coupled to the first header plate and receiving the cooling fluid from the manifold assembly; and
a plurality of fins coupled to the plurality of tubes;
wherein at least a first tube of the plurality of tubes closest to an initial intake of the charge air and closest to the first side sheet is exposed and free of the plurality of fins for a first distance from the first header plate, and wherein at least a majority of the plurality of tubes including up to all but the at least the first tube are exposed and free of the plurality of fins for a second distance from the first header plate, and wherein the second distance is less than the first distance.

2. The aftercooler of claim 1, wherein the first distance is between 25 mm and 75 mm, inclusive, and wherein the second distance is less than 15 mm.

3. The aftercooler of claim 1, wherein the at least the first tube is between one and three tubes.

4. The aftercooler of claim 1, wherein the at least the first tube is at least one of: a three tubes closest to the first side sheet and three rows of tubes closest to the initial intake of the charge air.

5. The aftercooler of claim 1, wherein the at least a majority of the plurality of tubes are positioned at an inner region of the core assembly inward of the at least the first tube relative to at least one of: the initial intake of the charge air and the first side sheet.

6. The aftercooler of claim 1, wherein the core assembly further includes:
a second header plate;
wherein the at least the first tube is exposed and free of the plurality of fins for the first distance from the second header plate, and wherein the at least the majority of the plurality of tubes including up to all but the at least the first tube are exposed and free of the plurality of fins for the second distance from the second header plate, and wherein the second distance is less than the first distance.

7. The aftercooler of claim 1, wherein the at least the first tube has a first plurality of rows of the plurality of fins coupled thereto, wherein the at least the majority of the plurality of tubes including up to all but the at least the first tube include a second plurality of rows of the plurality of fins, wherein the first plurality of rows is less than the second plurality of rows.

8. The aftercooler of claim 1, wherein the at least the first tube being exposed and free of the plurality of fins for the first distance reduces a thermal stress at a joint between the at least the first tube and the first header plate.

9. An aftercooler for cooling a charge air of an internal combustion engine, the aftercooler comprising:
a first side sheet;
a first header plate; and
a core assembly positioned adjacent the first header plate and the first side sheet, the core assembly comprising:
a plurality of tubes coupled to the first header plate; and
a plurality of rows of fins coupled to the plurality of tubes, wherein a first fin of the plurality of rows of fins coupled to at least a first tube of the plurality of tubes closest to the first side sheet has a first distance from the first header plate of between 25 mm and 75 mm, inclusive.

10. The aftercooler of claim 9, wherein at least the first tube has relatively less of the plurality of rows of fins coupled thereto compared with others of the plurality of tubes as a result of the at least the first tube being exposed and free of the plurality of rows of fins for a first distance from the first header plate.

11. The aftercooler of claim 10, wherein the others of the plurality of tubes include at least a majority of the plurality of tubes including up to all but the at least the first tube.

12. The aftercooler of claim 10, wherein the others of the plurality of tubes are positioned at an inner region of the core assembly inward of the at least the first tube relative to an initial intake of the charge air and the first side sheet.

13. The aftercooler of claim 9, wherein the at least the first tube is between one tube and up to three rows of tubes, inclusive.

14. The aftercooler of claim 9, wherein the at least the first tube is exposed and free of the plurality of rows of fins for the first distance.

15. A method of assembling an aftercooler of an internal combustion engine comprising:
providing a first header plate and a first side sheet;
coupling a plurality of tubes to the first header plate;
coupling at least a first tube of the plurality of tubes to a first plurality of fins while leaving the at least the first tube exposed and free of the first plurality of fins for a first distance from the header plate;
coupling a second number of the plurality of tubes to a second plurality of fins while leaving the second number of the plurality of tubes exposed and free of the second plurality of fins for a second distance from the header plate, wherein the second distance is less than the first distance; and
positioning the at least the first tube of the plurality of tubes to be a most adjacent of the plurality of tubes to the first side sheet.

16. The method of claim 15, wherein the first distance is between 25 mm and 75 mm, inclusive, and wherein the second distance is less than 15 mm.

17. The method of claim 15, wherein the at least the first tube is between a single tube and up to three rows of tubes, inclusive.

18. The method of claim 15, wherein the second number of the plurality of tubes include at least a majority of the plurality of tubes including up to all but the at least the first tube, and wherein the second number of the plurality of tubes are positioned at an inner region of a core assembly inward of the at least the first tube relative to an initial intake of a charge air and the first side sheet.

19. The method of claim 15, wherein the leaving the at least the first tube exposed and free of the first plurality of fins for the first distance reduces a thermal stress at a joint between the at least the first tube and the first header plate.

20. The method of claim 15, wherein the first plurality of fins is less than the second plurality of fins.
